(19) United States
(12) Patent Application Publication
(10) Pub. No.: US 2019/0242186 A1
(43) Pub. Date: Aug. 8, 2019

(54) HORIZONTAL BLIND STRUCTURE

(71) Applicant: Tser Wen CHOU, Yorba Linda, CA (US)

(72) Inventor: Tser Wen CHOU, Yorba Linda, CA (US)

(21) Appl. No.: 15/890,282

(22) Filed: Feb. 6, 2018

(51) Int. Cl. E06B 9/327; E06B 9/262; E06B 9/322

(52) U.S. Cl. CPC E06B 9/327; E06B 9/262; E06B 2009/3225; E06B 2009/2622; E06B 9/322

(57) ABSTRACT

A horizontal blind structure includes a blind rail, more than one slat control unit and more than one cord winding unit. The slat control unit includes a fixing seat and a control polygonal drum received in the fixing seat and a cord restriction seat. The control polygonal drum is connected with a ladder belt. The ladder belt extends along the cord restriction seat to connect with the slats so as to control the slats to rotate into a horizontal state or a vertical state for shading sunlight. The cord winding unit includes a cord winding tube passing through the cord restriction seat and a movable conic tube movably fitted on the cord winding tube. A pull cord is wound on the movable conic tube. Multiple guide wheels are disposed at lower end of the cord restriction seat for guiding the pull cord to be positioned at the center of the slats, whereby the slats can be tidily overlapped and the pull cord is prevented from tangling so as to enhance the sunshade effect.

### BACKGROUND OF THE INVENTION

### 1. Field of the Invention

The present invention relates generally to an improved horizontal blind structure, and more particularly to a horizontal blind, which has a simplified structure and is fast to install and has better sunshade effect.

### 2. Description of the Related Art

A conventional horizontal blind structure is designed with a U-shaped blind rail. A slat control unit and a pull cord control unit are mounted in the blind rail. With respect to the slat control unit, a fixing support is first mounted in the blind rail and then a control polygonal drum is disposed on the fixing support. A quadrangular rod is passed through the control polygonal drum. The quadrangular rod is connected with a bead chain control seat. The rotation of the quadrangular rod is controlled by means of pulling the bead chain so as to drive the control polygonal drum to rotate for controlling the slats into a horizontal open state or a vertical blocking state to shade the sunlight. The pull cord control unit has a pull cord connected to a lower weight of the slats at the bottommost end. The pull cord is passed through the respective slats to connect with a roller set disposed in the blind rail. The roller set changes the direction of the pull cord to connect the pull cord to a brake unit. The brake unit controls the slats to be lifted to a fixed position or lowered to a fixed position. A pull cord is further disposed on one side of the brake unit and suspends therefrom for a user to pull the pull cord so as to control the lifting/lowering of the slats.

The conventional horizontal blind has numerous components so that the cost for the conventional horizontal blind is quite high and the installation process of the conventional horizontal blind is quite complicated. Especially, all the components are positioned inside the U-shaped blind rail. Therefore, it is quite troublesome and time-consuming to assemble and mount these components in the narrow space. In addition, the power supply of the conventional horizontal blind for controlling the lifting/lowering of the slats is generally a bead chain. All the components are positioned inside the U-shaped blind rail so that the power supply can only employ a pull cord to control the lifting/lowering of the slats and cannot be replaced with any other power supply. This is quite troublesome to a user.

### SUMMARY OF THE INVENTION

It is therefore a primary object of the present invention to provide a horizontal blind structure to overcome the problems existing in the installation and operation of the conventional horizontal blind. The horizontal blind structure of the present invention has better sunshade effect and the installation process of the horizontal blind structure of the present invention is simplified and speeded. Moreover, different power supplies can be mounted to drive the pull cord so as to lower the cost and speed the installation.

To achieve the above and other objects, the horizontal blind structure of the present invention mainly includes a blind rail, more than one slat control unit and more than one cord winding unit. The blind rail is securely disposed on an upper edge of a widow or a ceiling. The blind rail has a recess with a connection face space for connecting with the slat control unit. The slat control unit includes a fixing seat securely disposed in the blind rail and a control polygonal drum received in the fixing seat and a cord restriction seat. The control polygonal drum is connected with a ladder belt. The ladder belt downward extends along the cord restriction seat to connect with the respective slats so as to control the slats to rotate into a horizontal state permitting light to pass through or a vertical state for shading sunlight. The cord winding unit is mounted under the blind rail via a set of locating support. The cord winding unit includes a cord winding tube passing through the cord restriction seat and a movable conic tube movably fitted on the cord winding tube. A pull cord is wound on the movable conic tube for winding or unwinding the pull cord. The conic configuration of the conic tube serves to restrict the pull cord to be tidily wound on the movable conic tube. Multiple guide wheels are disposed at lower end of the center of the cord restriction seat for guiding and locating the pull cord to be positioned at the center of the slats, whereby the slats can be collected or released in a balanced state without tilting and tangling so as to enhance the sunshade effect of the blind.

The horizontal blind structure of the present invention is composed of less of components and has a simplified structure and can be quickly assembled and installed to achieve better sunshade effect.

The present invention can be best understood through the following description and accompanying drawings, wherein:

### BRIEF DESCRIPTION OF THE DRAWINGS

FIG. 1 is a perspective exploded view of the present invention;

FIG. 2 is a perspective assembled view of the slat control unit of the present invention;

FIG. 3 is a perspective exploded view of the cord restriction seat of the slat control unit of the present invention;

FIG. 4 is a perspective assembled view of the cord restriction seat of the slat control unit of the present invention;

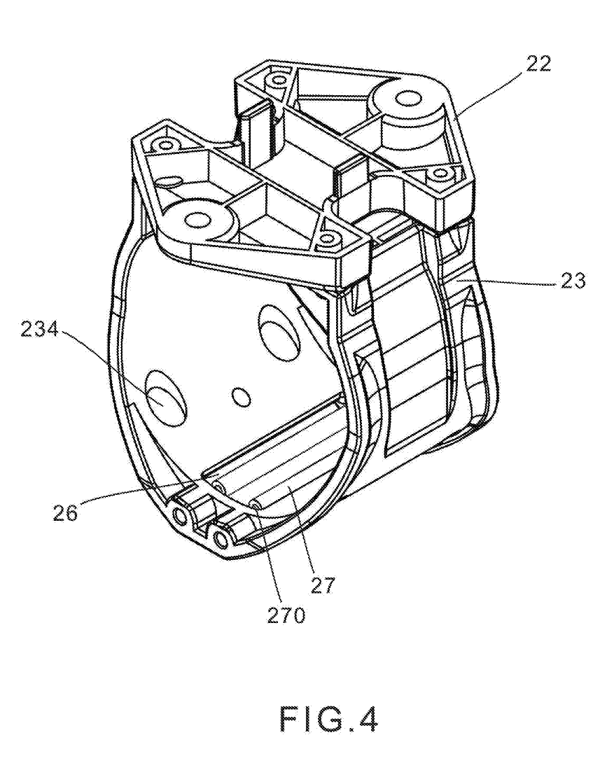

FIG. 5 is a perspective exploded view of the slat control unit of the present invention;

FIG. 6 is a perspective exploded view of the cord winding unit of the present invention;

FIG. 7 is a perspective assembled view of the cord winding unit of the present invention;

FIG. 8 is a perspective assembled view of the cord winding unit and the slat control unit of the present invention;

FIG. 9 is a view showing the operation of the cord winding unit of the present invention;

FIG. 10 is a sectional assembled view of the present invention;

FIG. 11 is a perspective assembled view of the present invention;

FIG. 12 is a view showing the installation of the slats of the present invention;

FIG. 13 is a view showing that the slats of the present invention are positioned in a vertical state to shade sunlight;

FIG. 14 is a perspective view of an embodiment of the power supply for the cord winding unit of the present invention;

FIG. 15 is a perspective view of another embodiment of the power supply for the cord winding unit of the present invention; and

FIG. 16 is a perspective view of still another embodiment of the power supply for the cord winding unit of the present invention.

### DETAILED DESCRIPTION OF THE PREFERRED EMBODIMENTS

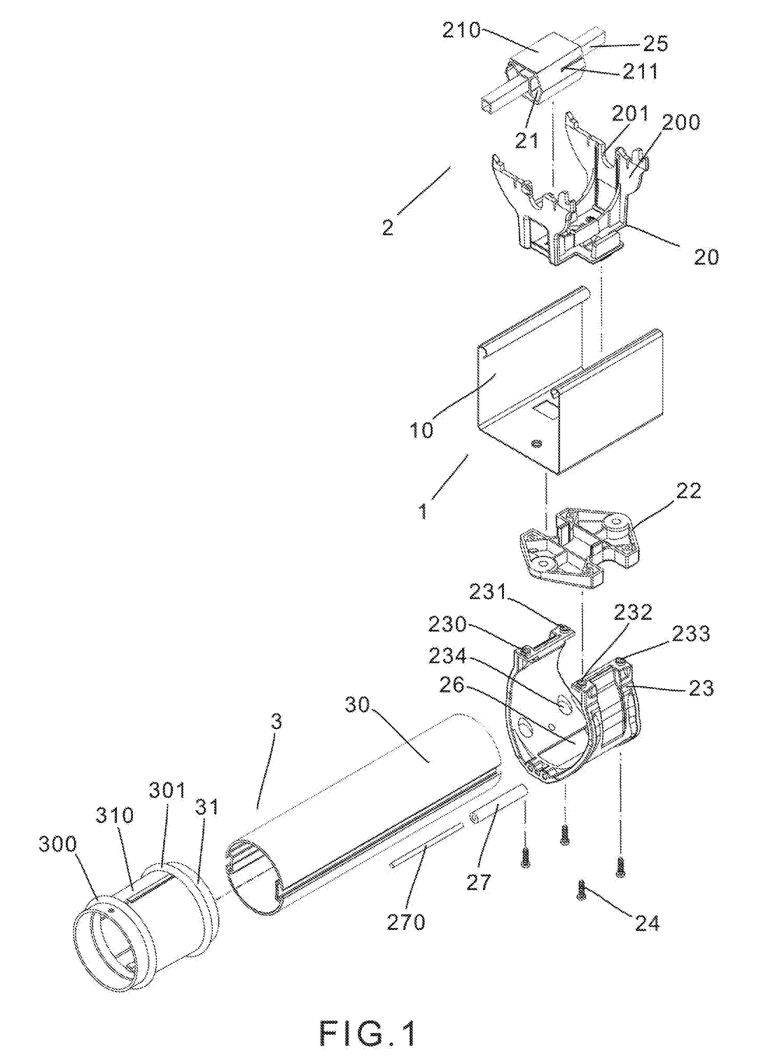

Please refer to FIG. 1. The horizontal blind of the present invention mainly includes a blind rail 1, more than one slat control unit 2 and more than one cord winding unit 3.

As shown in FIG. 1, the blind rail 1 is a U-shaped structure. A fixing bracket can be connected with the blind rail 1 to affix the blind rail 1 to a ceiling or an upper edge of a window. The blind rail 1 has a receiving space 10 for receiving the slat control unit 2.

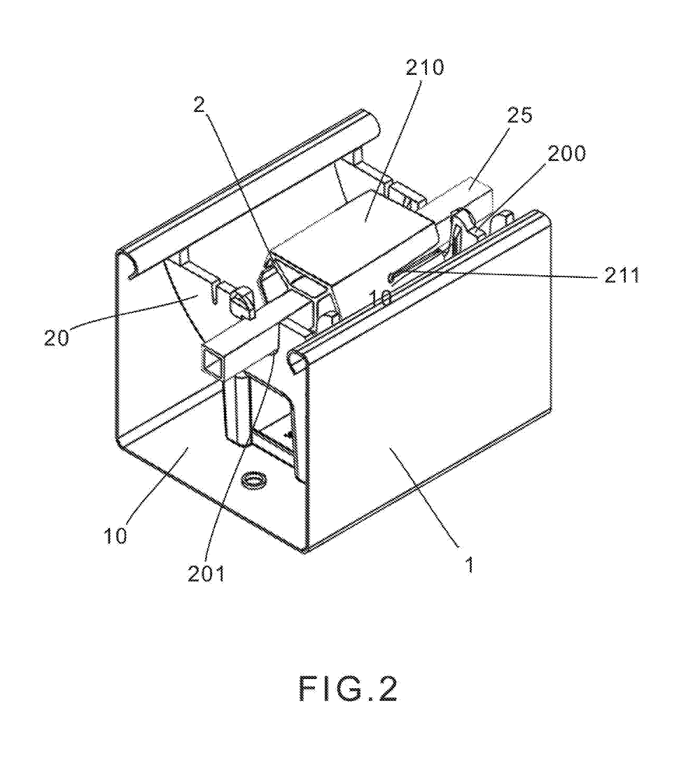

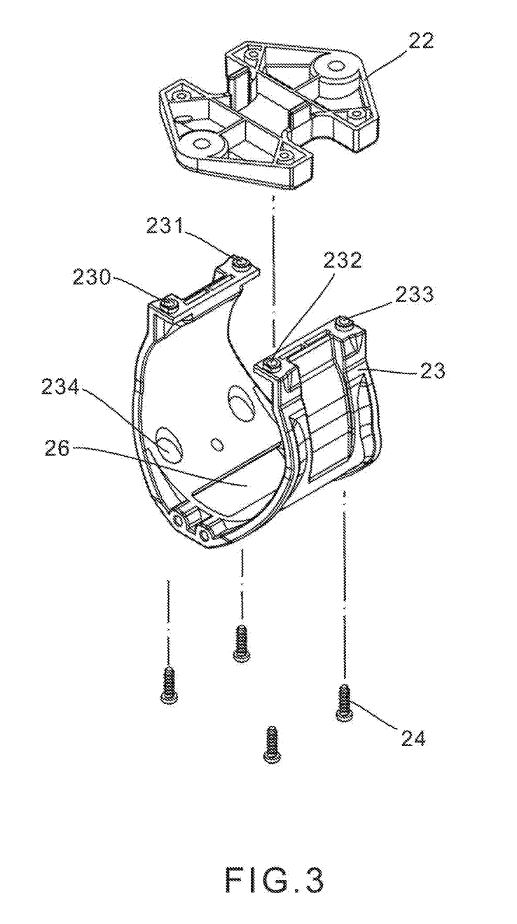

Referring to FIGS. 2 and 3, the slat control unit 2 includes a fixing seat 20 connected in the receiving space 10 of the blind rail 1 and a control polygonal drum 21 connected in an internal space of the fixing seat 20 and a cord restriction seat 23 locked under the blind rail 1 by means of a locating seat 22.

Referring to FIGS. 1 and 2, two support plates 200 are disposed on two sides of the main body of the fixing seat 20 for supporting and mounting the fixing seat 20 in the blind rail 1. Each support plate 200 is formed with an arched notch 201. In addition, the bottom of the fixing seat 20 is formed with two perforations. A ladder belt is connected with the control polygonal drum 21 and conducted downward through the perforations along the cord restriction seat 23 to connect with the respective slats.

A quadrangular tube 25 is passed through the control polygonal drum 21 and rested on the arched notches 201 on two sides of the fixing seat. A power supply is connected to the quadrangular tube 25 for driving the control polygonal drum 21 to rotate. The main body of the control polygonal drum 21 is a hexagonal body composed of six plane faces 210 connected with each other. Two cord slits 211 are formed on two opposite plane faces, whereby the ladder belt is secured in the cord slits 211 and drivable by the control polygonal drum 21.

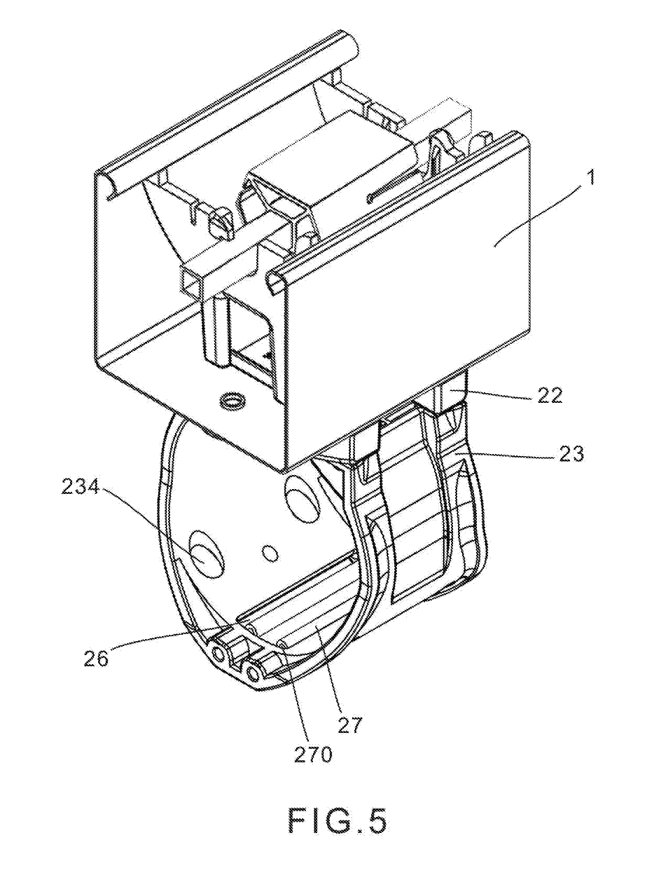

The locating seat 22 has two threaded hole seats on which two threaded holes are formed. Two screws are screwed through the threaded holes of the threaded hole seats to affix the locating seat 22 under the blind rail 10. The locating seat 22 further has four threaded hole and two sides of top end of the cord restriction seat 23 are formed with threaded holes 230, 231, 232, 233 corresponding to the threaded holes of the locating seat 22. The wall face of the cord restriction seat 23 is formed with through holes 234. Screws 24 are passed through the through holes 234 and screwed through the threaded holes 230, 231, 232, 233 into the threaded holes of the locating seat 22 so as to integrally lock the cord restriction seat 23 under the locating seat 22. Then the locating seat 22 with the cord restriction seat 23 is affixed under the blind rail 1 (as shown in FIG. 5). In addition, the bottom of the cord restriction seat 23 is formed with a cord outlet 26. More than one set of guide wheels 27 can be mounted in the cord outlet 26. A shaft rod 270 is passed through each guide wheel 27, whereby the guide wheel 27 can be rotated to guide a pull cord wound on a movable conic tubular body. The pull cord downward extends through the respective slats to connect with a lower weight. The pull cord serves to control the collection and releasing of the slats.

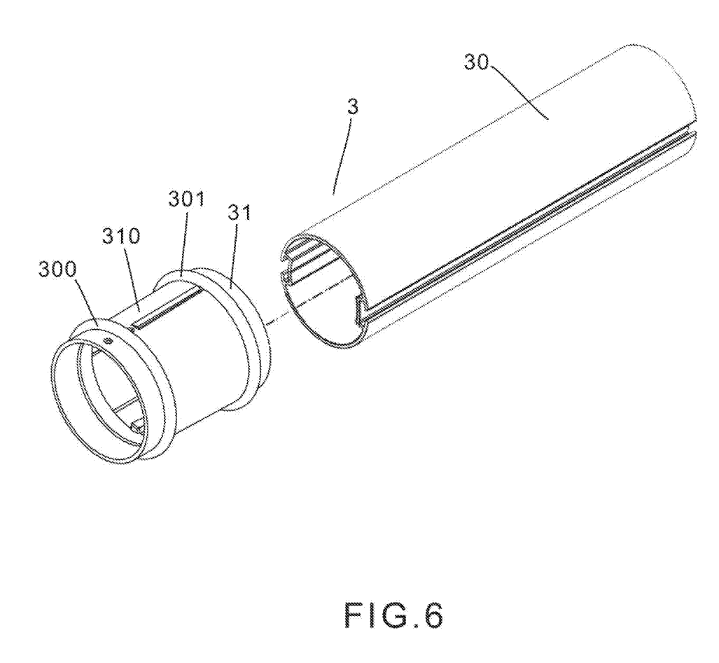

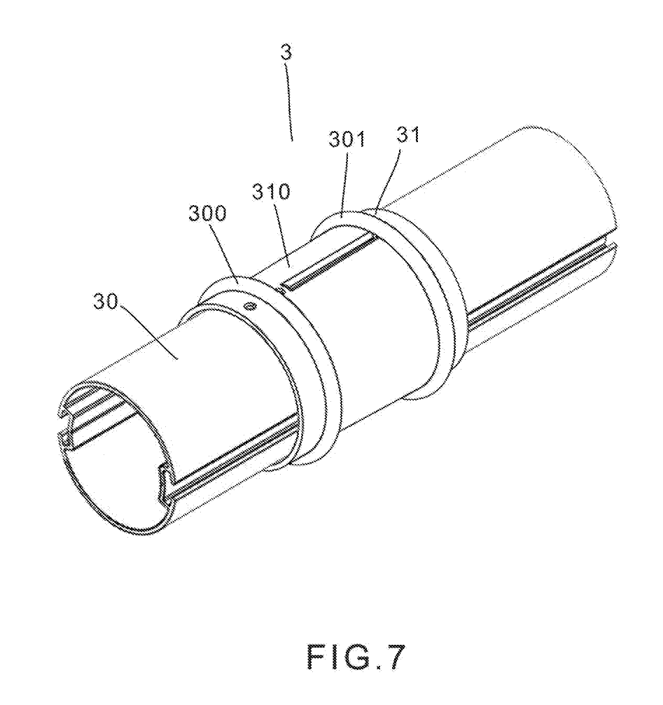

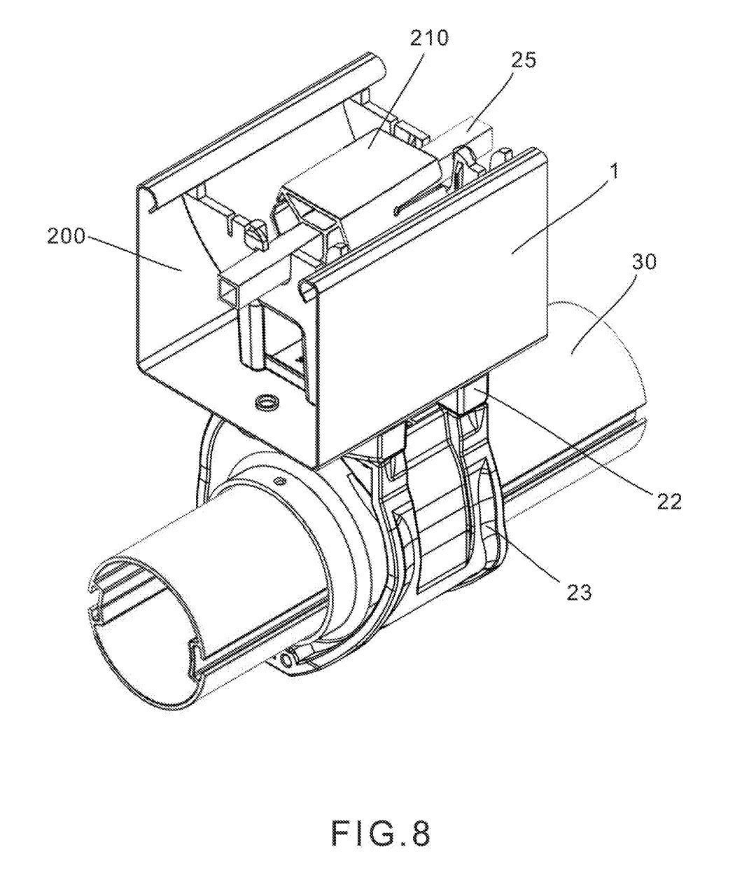

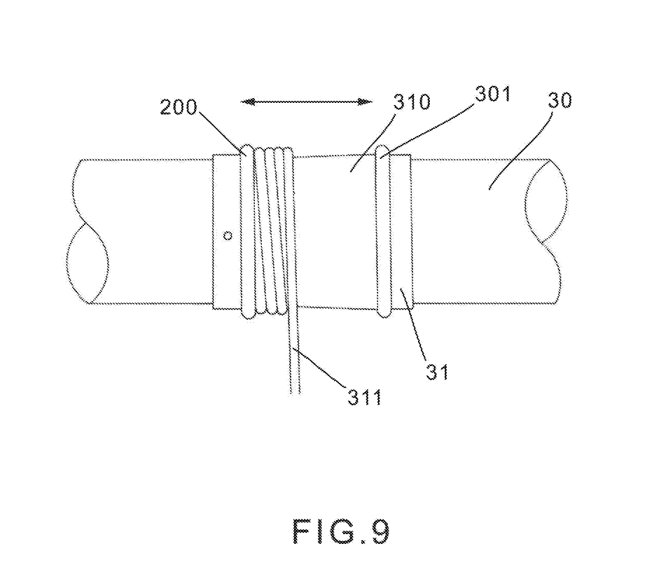

As shown in FIGS. 6 and 7, the cord winding unit 3 includes a cord winding tube 30 passing through the cord restriction seat 23 and a movable conic tube 31 movably fitted on the cord winding tube 30. Two annular ribs 300, 301 are formed on two sides of the tubular body of the movable conic tube 31 to restrict the pull cord to be only wound on a certain section of the tubular body. The tubular body of the movable conic tube 31 is a conic tubular body 310 with a specific angle. The conic tubular body 310 serves to guide the pull cord 311 to be more tidily wound on the tubular body without tangling (as shown in FIGS. 8 and 9).

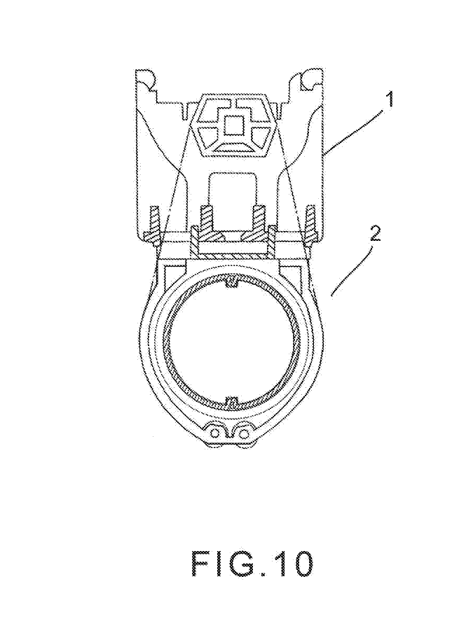

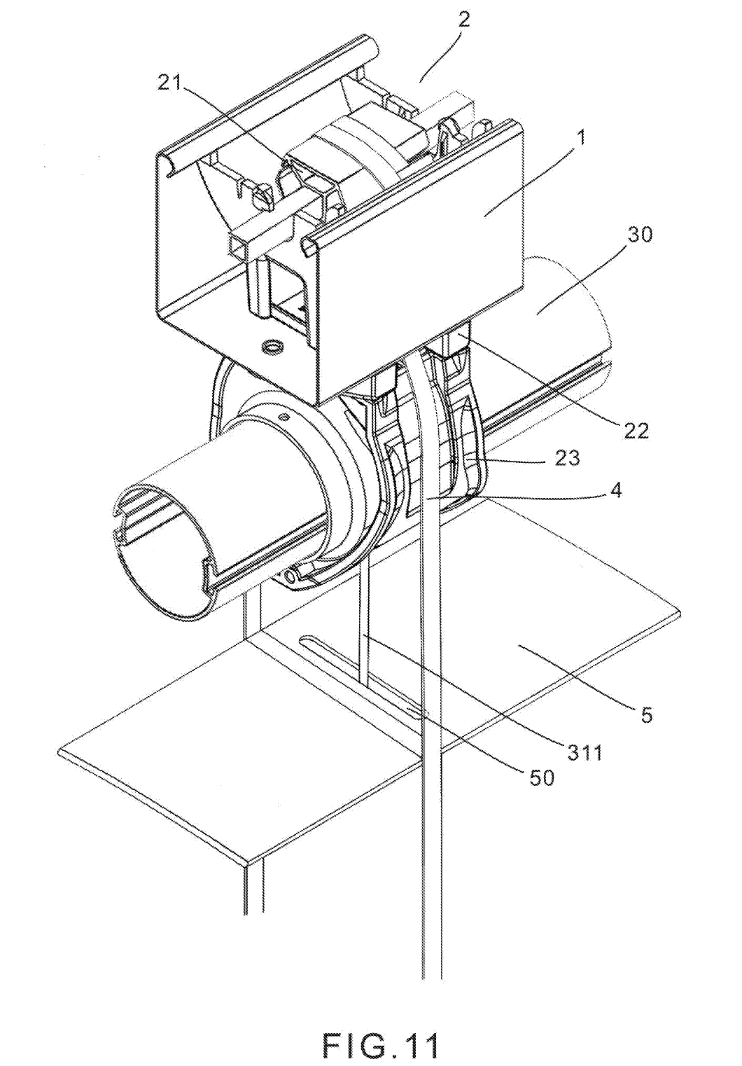

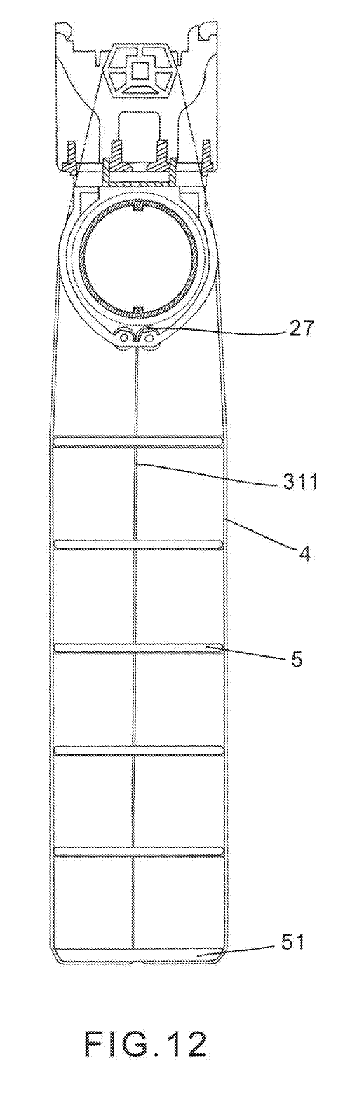

Please now refer to FIGS. 10, 11 and 12. When assembled, the slat control unit 2 is locked under the blind rail 1 and two ladder belts 4 of the control polygonal drum 21 downward extend to connect with two lateral ends of the respective slats 5. The pull cord wound on the movable conic tube 31 of the cord winding unit 3 is downward conducted out of the cord restriction seat 23 along the inner face of the cord restriction seat 23. The pull cord 311 is guided by the guide wheel 27 to be positioned at the center of the cord restriction seat 23. The pull cord 311 is then sequentially passed through the slots 50 of the respective slats 5 to connect with the lower weight 51 at the bottom so as to control the overlapping/collection and releasing of the slats 5. The entire horizontal blind with the blind rail 1 is further affixed to a ceiling or an upper edge of a window by means of the fixing bracket to complete the assembly and installation of the horizontal blind (as shown in FIGS. 11 and 12).

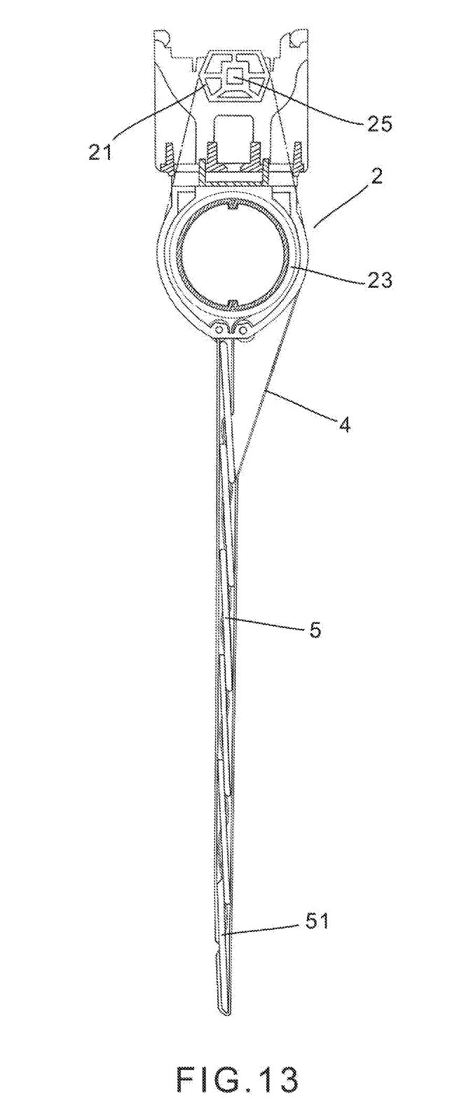

When it is desired to shade the sunlight (as shown in FIG. 13), the power supply drives the quadrangular tube 25 to rotate so as to drive the control polygonal drum 21 of the slat control unit 2 to rotate. At this time, one side of the ladder belt 4 is lifted, while the other side of the ladder belt 4 is lowered. The ladder belt 4 is guided by the arc of the cord restriction seat 23, whereby when the slats 5 is turned into a vertical state to shade the sunlight, the uppermost slat 5 will abut against the bottom end of the cord restriction seat 23 so that the slats 5 can more snugly attach to each other to enhance the sunshade effect.

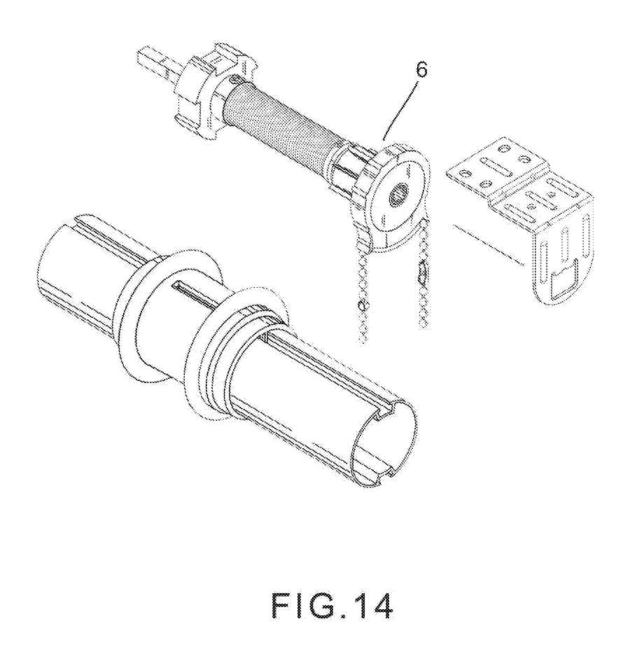

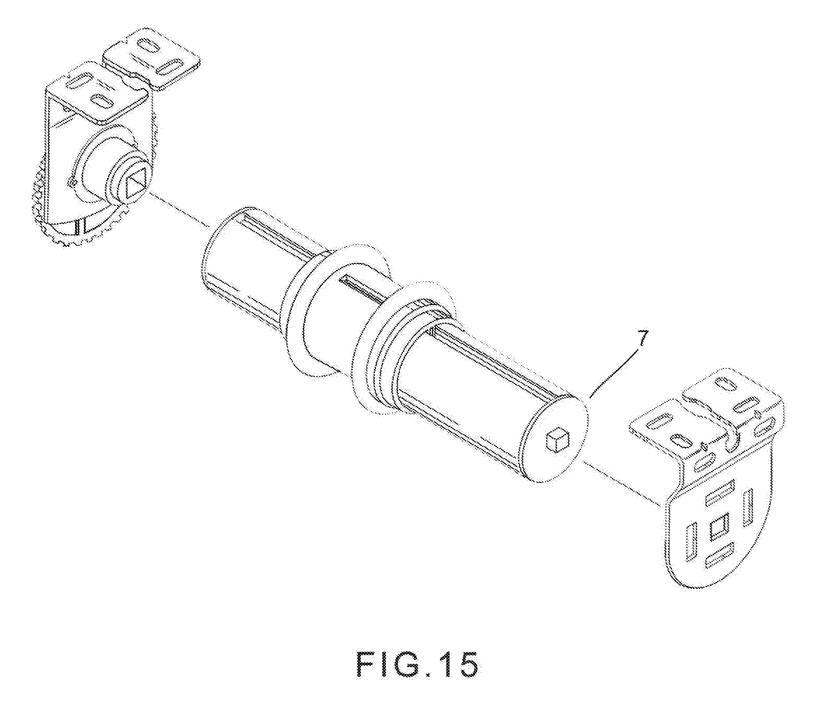

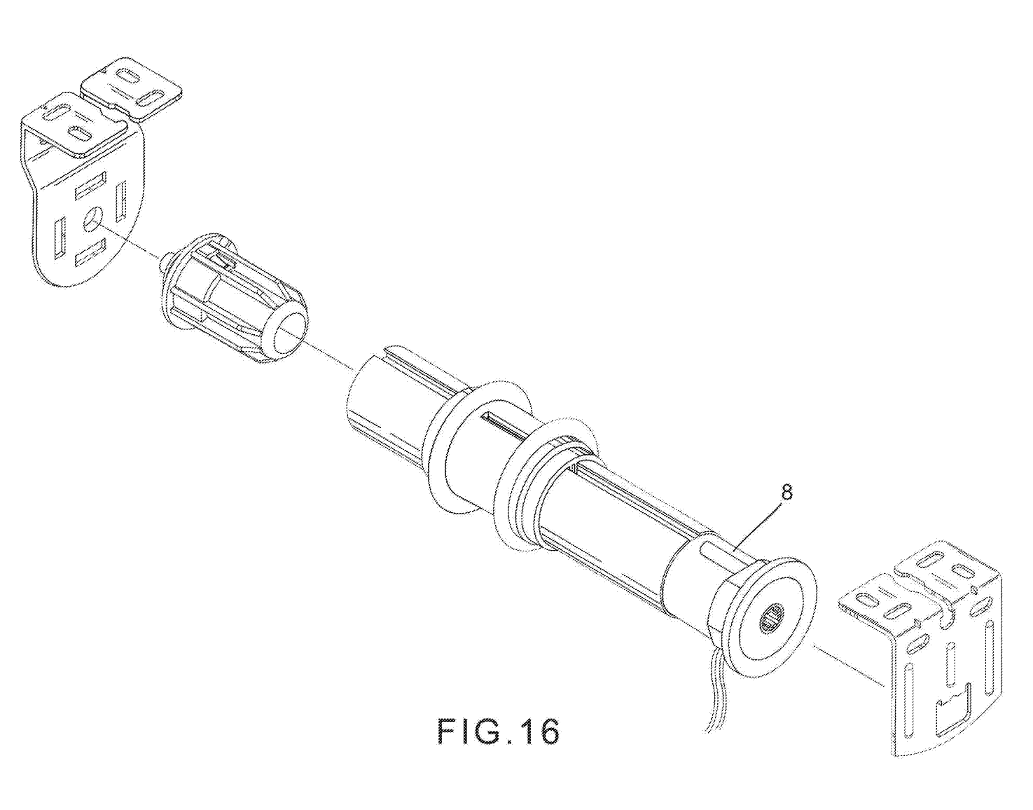

Please now refer to FIGS. 14 to 16. The power supply for supplying rotational power for the cord winding unit 3 of the present invention can be a bead chain controller 6, a cordless controller 7 or an automatic winder 8 mounted on one side of the cord winding tube 30 of the cord winding unit 3 for supplying rotational power to rotate the cord winding tube. Accordingly, the pull cord is driven to collect the slats or release the slats.

The above embodiments are only used to illustrate the present invention, not intended to limit the scope thereof. Many modifications of the above embodiments can be made without departing from the spirit of the present invention.

What is claimed is:

1. A horizontal blind structure comprising:
a blind rail having a receiving space for receiving a slat control unit, the slat control unit being securely connected with the blind rail by means of screws;
more than one slat control unit, each slat control unit including a fixing seat connected in the receiving space of the blind rail and a control polygonal drum connected in an internal space of the fixing seat and a cord restriction seat locked under the blind rail by means of a locating seat;
more than one cord winding unit, each cord winding unit including a cord winding tube passing through the cord restriction seat and a movable conic tube movably fitted on the cord winding tube; and
more than one set of guide wheels for guide a pull cord wound on the movable conic tube, the movable conic tube being fitted on the cord winding tube rotationally drivable by a power supply, the tubular body of the movable conic tube being a conic tubular body with tapered diameter, the conic tubular body serving to guide the pull cord to be tidily wound on the movable conic tube, the end of the pull cord extending along the cord restriction seat to be guided by the guide wheel to be positioned at the center of the cord restriction seat, the pull cord being then sequentially passed through the respective slats to connect with the lower weight so as to control the overlapping/collection and releasing of the slats to complete the assembly and installation of the horizontal blind.

2. The horizontal blind structure as claimed in claim 1, wherein the locating seat has two threaded hole seats secured under the blind rail by means of screws and several threaded holes for connecting with the cord restriction seat.
